(19) United States
(12) Patent Application Publication
(10) Pub. No.: US 2026/0341976 A1
(43) Pub. Date: Oct. 29, 2026

(54) AUTONOMOUS INTERFERENCE-RESISTANCE GEOSPATIAL ANTENNA SYSTEM AND METHOD OF OPERATING SAME

(71) Applicant: Defender LLC, Lutherville-Timonium, MD (US)

(72) Inventor: Evangelos Foutzitzis, Nottingham, MD (US)

(21) Appl. No.: 19/192,985

(22) Filed: Apr. 29, 2025

(51) Int. Cl. H01Q 21/20; H01Q 3/24; H04B 1/00; H04B 7/06

(52) U.S. Cl. CPC H01Q 21/205; H01Q 3/24; H04B 1/0003; H04B 7/0608

(57) ABSTRACT

An autonomous interference-resistance geospatial antenna system is described herein. The autonomous interference-resistance geospatial antenna system includes an antenna array including a plurality of directional Radio Frequency (RF) antennas, each directional RF antenna orientated in a different geographic direction, an RF switching device coupled to the antenna array and configured to selectively operate each directional RF antenna, and a control system operatively coupled to the RF switching device and antenna array. The control system includes an attitude sensing device configured to determine geographic directional values of each directional RF antenna including a corresponding geographic location and orientation, a software defined radio (SDR) device configured to determine a signal to noise ratio (SNR) value for each directional RF antenna, and a control unit including one or more processors programed to execute an algorithm to operate the antenna array.

### FIELD OF THE DISCLOSURE

The present invention relates to directional radio frequence (RF) antennas, and more particularly, to autonomous interference-resistance geospatial antenna systems.

### BACKGROUND

At least some known directional antennas operate such that as the gain of a directional antenna increases, the angle of radiation usually decreases. This provides a greater coverage distance, but with a reduced coverage angle. However, due to the reduced coverage angle, known directional antennas may be affected by interference signals which decrease the operating efficiency of the directional antennas.

The present invention is aimed at one or more of the problems identified above.

### SUMMARY OF THE INVENTION

In one aspect of the present invention, an autonomous interference-resistance geospatial antenna system is provided. The autonomous interference-resistance geospatial antenna system includes an antenna array including a plurality of directional Radio Frequency (RF) antennas, each directional RF antenna orientated in a different geographic direction, an RF switching device coupled to the antenna array and configured to selectively operate each directional RF antenna, and an antenna control system operatively coupled to the RF switching device and antenna array. The antenna control system includes an attitude sensing device configured to determine geographic directional values of each directional RF antenna including a corresponding geographic location and orientation, a software defined radio (SDR) device configured to determine a signal to noise ratio (SNR) value for each directional RF antenna, and a control unit. The control unit includes one or more processors programed to execute an algorithm to operate the antenna array including the steps of receiving a request including a geographic target location, receiving current geographic directional values of each directional RF antenna from the attitude sensing device, receiving current SNR values for each directional RF antenna from the SDR device, selecting a directional RF antenna based on the current SNR values, the current geographic directional values, and the received geographic target location, and operating the RF switching device to activate the selected directional RF antenna.

In another aspect of the present invention, a method of operating an autonomous interference-resistance geospatial antenna system is provided. The autonomous interference-resistance geospatial antenna system includes an antenna array including a plurality of directional Radio Frequency (RF) antennas, each directional RF antenna orientated in a different geographic direction, an RF switching device coupled to the antenna array and configured to selectively operate each directional RF antenna, and an antenna control system operatively coupled to the RF switching device and antenna array. The antenna control system includes an attitude sensing device configured to determine geographic directional values of each directional RF antenna including a corresponding geographic location and orientation, a software defined radio (SDR) device configured to determine a signal to noise ratio (SNR) value for each directional RF antenna, and a control unit including one or more processors. The method includes the one or more processors performing an algorithm to operate the antenna array including the steps of receiving a request including a geographic target location, receiving current geographic directional values of each directional RF antenna from the attitude sensing device, receiving current SNR values for each directional RF antenna from the SDR device, selecting a directional RF antenna based on the current SNR values, the current geographic directional values, and the received geographic target location, and operating the RF switching device to activate the selected directional RF antenna.

In yet another aspect of the present invention, a non-transitory computer-readable storage media having computer-executable instructions embodied thereon to operate an autonomous interference-resistance geospatial antenna system is provided. The autonomous interference-resistance geospatial antenna system includes an antenna array including a plurality of directional Radio Frequency (RF) antennas, each directional RF antenna orientated in a different geographic direction, an RF switching device coupled to the antenna array and configured to selectively operate each directional RF antenna, and an antenna control system operatively coupled to the RF switching device and antenna array. The antenna control system includes an attitude sensing device configured to determine geographic directional values of each directional RF antenna including a corresponding geographic location and orientation, a software defined radio (SDR) device configured to determine a signal to noise ratio (SNR) value for each directional RF antenna, and a control unit including one or more processors. When executed by the one or more processors the computer-executable instructions cause the one or more processors to perform an algorithm including the steps of receiving a request including a geographic target location, receiving current geographic directional values of each directional RF antenna from the attitude sensing device, receiving current SNR values for each directional RF antenna from the SDR device, selecting a directional RF antenna based on the current SNR values, the current geographic directional values, and the received geographic target location, and operating the RF switching device to activate the selected directional RF antenna.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIGS. 1 and 2 are schematic views illustrating various aspects of an autonomous interference-resistance geospatial antenna system, according to embodiments of the present invention;

FIGS. 3 and 4 are perspective views of portions of the autonomous interference-resistance geospatial antenna system shown in FIGS. 1 and 2;

FIGS. 5 and 6 are flowcharts of algorithms that may be performed for operating the autonomous interference-resistance geospatial antenna system shown in FIGS. 1 and 2, according to embodiments of the present invention; and

FIGS. 7 and 8 are schematic illustrations of graphical user interfaces that may be displayed on graphic user interface device screens when operating the autonomous interference-resistance geospatial antenna system shown in FIGS. 1 and 2.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention.

### DETAILED DESCRIPTION

With reference to the drawings and in operation, the embodiments of the present invention provide an autonomous interference-resistance geospatial antenna system 10 designed to optimize signal reception in a multi-antenna RF setup by dynamically selecting the antenna with the highest signal quality while mitigating interference. The system consists of an RF switch with four directional antennas, each covering a 90-degree sector to provide complete 360-degree coverage. A software-controlled process continuously evaluates the signal-to-noise ratio (SNR) of each antenna and selects the optimal one for improved communication performance. The system integrates with a Software-Defined Radio (SDR) to measure SNR values and a control circuit that enables seamless switching between antennas based on real-time conditions. The ultimate goal is to ensure reliable signal reception by automatically avoiding directions with high interference.

The system 10 includes an advanced geospatial antenna system uniquely capable of autonomously selecting radiating elements based on both geographic direction and interference patterns in its operating environment. Unlike prior technologies that focused solely on static direction-based antenna selection, the system of the present invention uses real-time interference detection to optimize its signal clarity dynamically, regardless of the antenna's geographic orientation.

This interference-resistant geospatial antenna system 10 introduces a groundbreaking method of autonomously selecting directional antennas, designed specifically for interference resilience, and represents a new approach to geospatial antenna technology by incorporating an interference-aware response, establishing a distinct and innovative advancement over existing geospatial antenna systems.

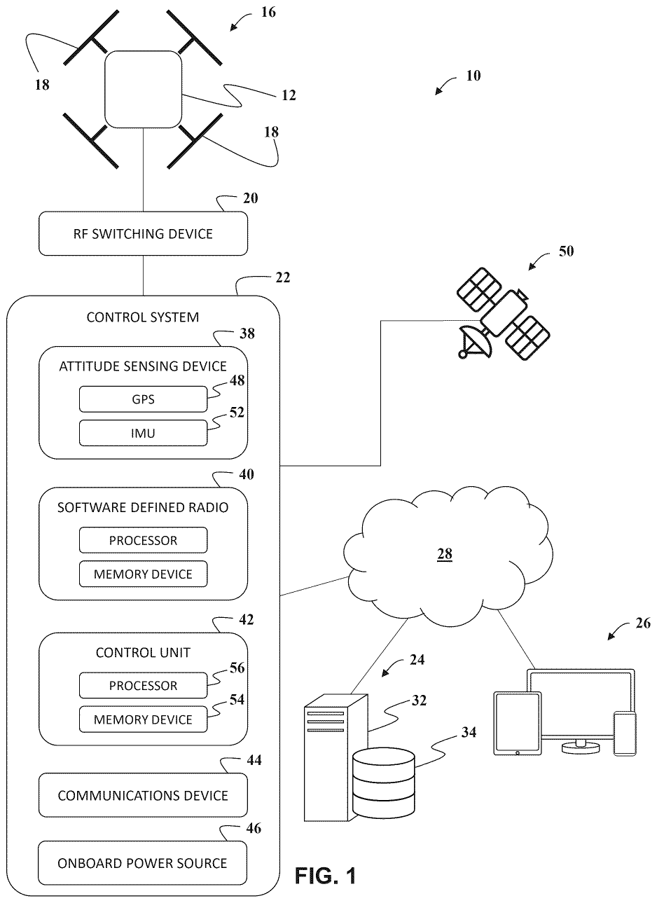

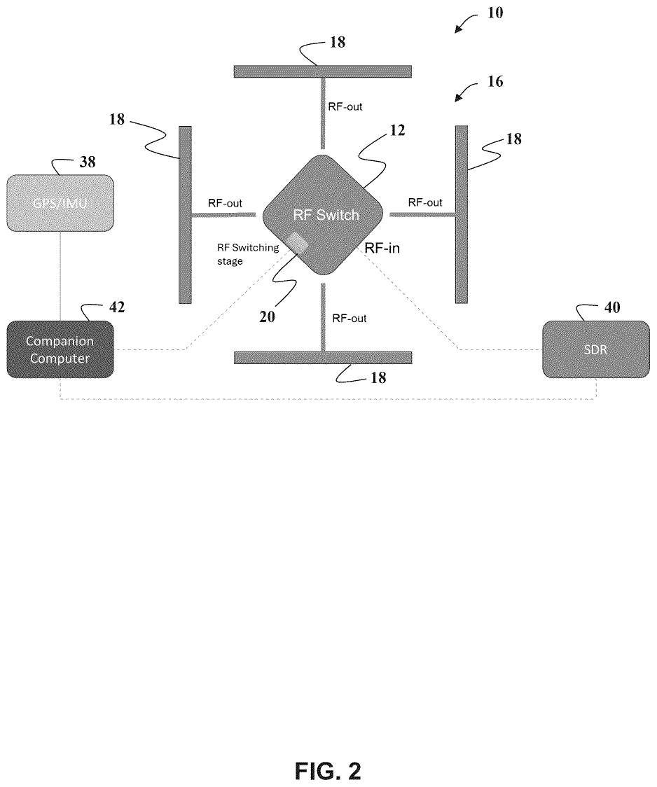

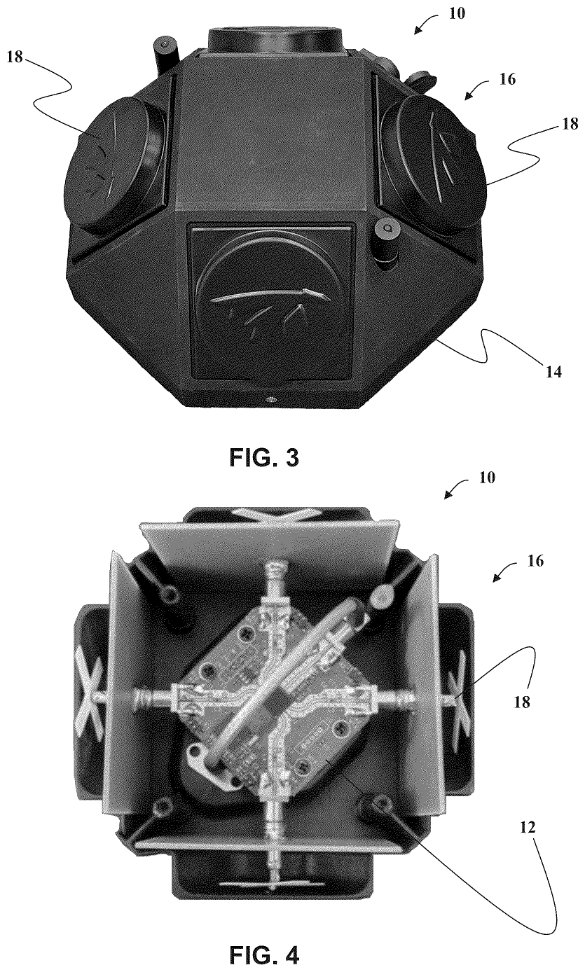

Referring to FIGS. 1-8, in the illustrated embodiment, the autonomous interference-resistance geospatial antenna system 10 includes a printed circuit board (PCB) 12 positioned within a housing 14, an antenna array 16 coupled to the PCB 12 and including a plurality of directional Radio Frequency (RF) antennas 18, an RF switching device 20 mounted to the PCB 12 and coupled to the antenna array 16, and an antenna control system 22 mounted to the PCB 12 and operatively coupled to the RF switching device 20 and the antenna array 16. The autonomous interference-resistance geospatial antenna system 10 may also a system server 24 and one or more user computing devices 26 that are coupled in communication with the antenna control system 22 via a communications network 28.

The communications network 28 may be any suitable connection, including the Internet, file transfer protocol (FTP), an Intranet, a local area network (LAN), a wide area network (WAN), dial-in-connections, a virtual private network (VPN), cellular networks, and/or any suitable communications network, and may utilize any suitable or combination of technologies including, but not limited to wired and wireless connections, always on connections, connections made periodically, and connections made as needed.

The user computing devices 26 include any suitable device that enables a user to access and communicate with the antenna control system 22 and/or the system server 24 including sending and/or receiving information to and from the antenna control system 22 and/or the system server 24, and displaying information received from the antenna control system 22 and/or the system server 24 to a user. For example, the user computing devices 26 may include, but is not limited to, smartphone, a tablet computer, smartphone/tablet computer hybrid, a desktop computer, a laptop or notebook computer, a personal data assistant, a handheld mobile device including a cellular telephone, and the like. The user computing devices 26 include one or more processors coupled to a memory device for storing various programs and data for use in operating the user computing device 26, and a display device including a graphical user interface (GUI) display screen 30 displaying computer-generated images thereon.

The system server 24 includes a central processing unit (CPU) 32 and a database 34. The CPU 32 includes one or more processors and a memory device and executes various programs, and thereby controls components of the system server 24 according to user instructions received from the user computing device 26 and/or antenna control system 22. The memory device stores various programs and information in the database 34, and retrieves information from the database 34 that is used by the processor to perform various functions described herein. In some embodiments, the CPU 32 may be programmed to host a website that is accessible by a user via one or more user computing devices 26. The CPU 32 retrieves and stores web pages from the database 34 and displays the webpages 36 on the user computing devices 26 to allow users to interact with the antenna control system 22 and/or the system server 24. The database 34 contains information on a variety of matters, such as, for example, computer-graphic image data and geographic location data for use in rendering three-dimensional topographic maps on the user computing device GUI display screens including geographic location and bearing of the antenna array 16 and directional RF antennas 18, and signal to noise (SNR) data.

In the illustrated embodiment, the antenna array 16 includes four directional RF antennas 18 with 90-degree beamwidths covering full azimuthal space (0°, 90°, 180°, 270°). Each directional RF antennas 18 is oriented in a different geographic direction and connected to the central RF switching device 20. The RF switching device 20 includes a four-output RF switch that allows one directional RF antenna 18 to be active at a time, and an RF switching stage microcontroller-based circuit configured to manage antenna switching via commands received from the antenna control system 22. The RF switching device 20 is coupled to the antenna array 16 and configured to selectively operate each directional RF antenna 18.

The antenna control system 22 includes an attitude sensing device 38, a software defined radio (SDR) device 40, a control unit 42, a communications device 44, and an onboard power source 46.

The attitude sensing device 38 is configured to determine geographic directional values of each directional RF antenna including a corresponding geographic location and orientation. The attitude sensing device 38 includes a Global Positioning System (GPS) 48 configured to communicate with GPS satellites 50 and generate geolocation data based on location and time information received from the GPS satellites 50, and an Inertial Measurement Unit (IMU) module 52 that includes an accelerometer, a gyroscope, and/or a magnetometer for use in determining real-time orientation and location data of the directional RF antennas 18. The attitude sensing device 38 plays a crucial role in converting locally referenced antenna bearings (relative to the device) into geospatial bearings (relative to the Earth's coordinate system). By integrating GPS position data with IMU-derived orientation, the attitude sensing device 38 can accurately determine the antenna's direction relative to global coordinates such as latitude and longitude.

The software defined radio (SDR) device 40 includes one or more processors executing an SNR algorithm for determining a signal to noise ratio (SNR) value for each directional RF antenna 18. The SDR device 40 is a dual use component that executes the SNR algorithm including the steps of operating the RF switching device 20 to capture RF signal levels from each directional RF antenna 18 and providing SNR metrics for performance evaluation. The SDR device 40 receives the signal of interest once the optimal antenna has been determined.

The control unit 42 includes a memory device 54 storing computer-executable instructions for performing an algorithm to operate the antenna array 16, and one or more processors 56 programmed to execute the computer-executable instructions to perform the algorithm to operate the antenna array 16. For example, the control unit 42 may include a companion computer interface including a software interface (running on a PC or embedded device) to control switching logic and perform data analysis.

The communications device 44 is configured to communicate with the system server 24 and/or the user computing devices 26 via the communications network 28 to enable a user to operate the autonomous interference-resistance geospatial antenna system 10 via computer-generated monitoring dashboards 36 displayed on the GUI display screen 30 of the user computing devices 26. For example, the communications device 44 may include a Wi-Fi antenna, a cellular network antenna, a Bluetooth™ communications device, USB interfaces, Ethernet™ interfaces, coaxial cable interfaces, and/or any suitable wired and/or wireless communication interface for communicating with the communications network 28. The onboard power source 46 may be, for example, a portable battery and/or solar powered unit for providing power to the components of the autonomous interference-resistance geospatial antenna system 10.

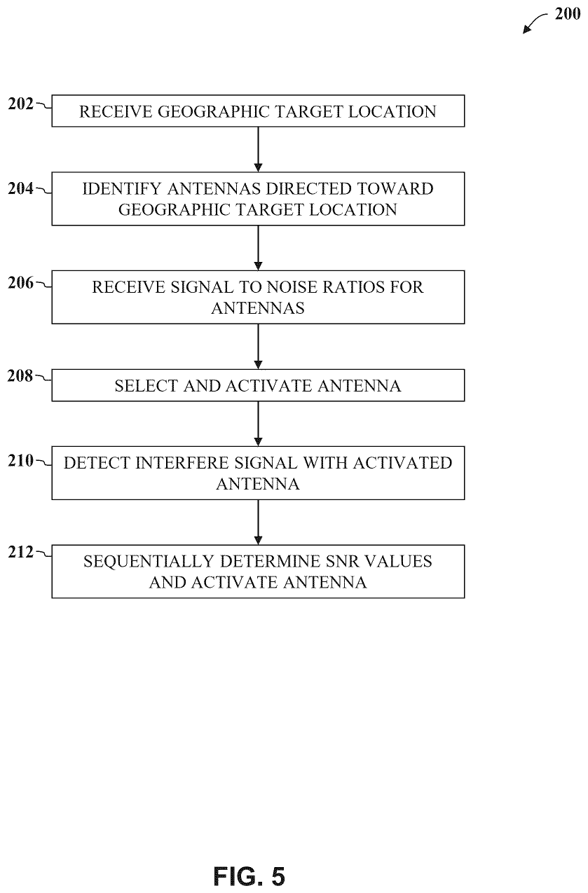

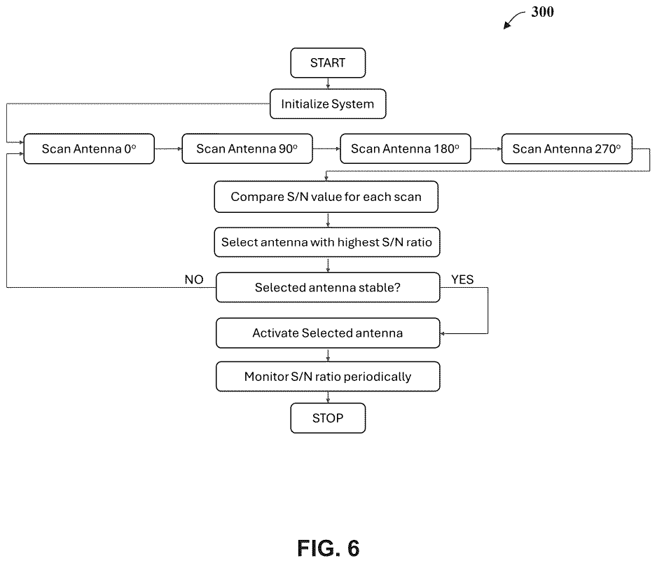

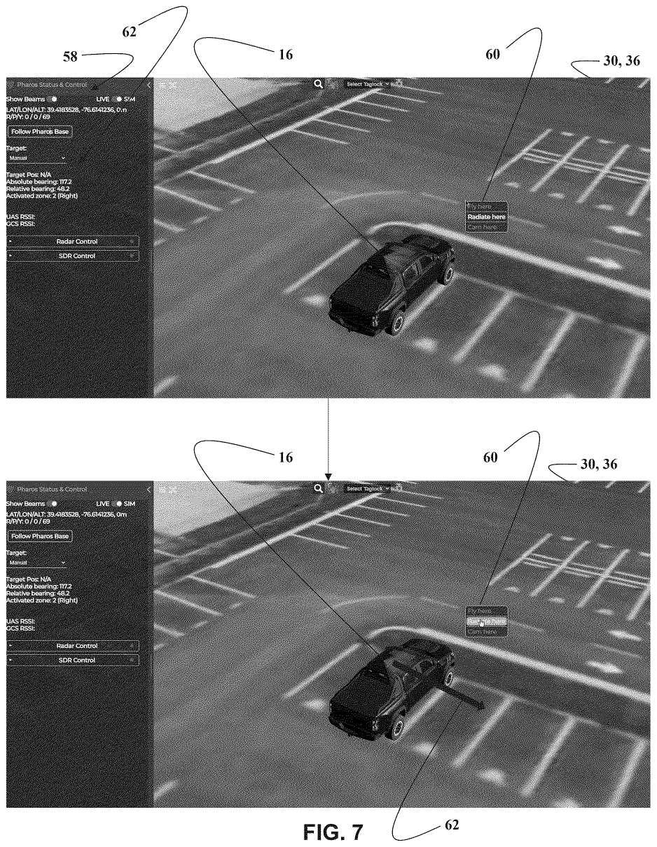

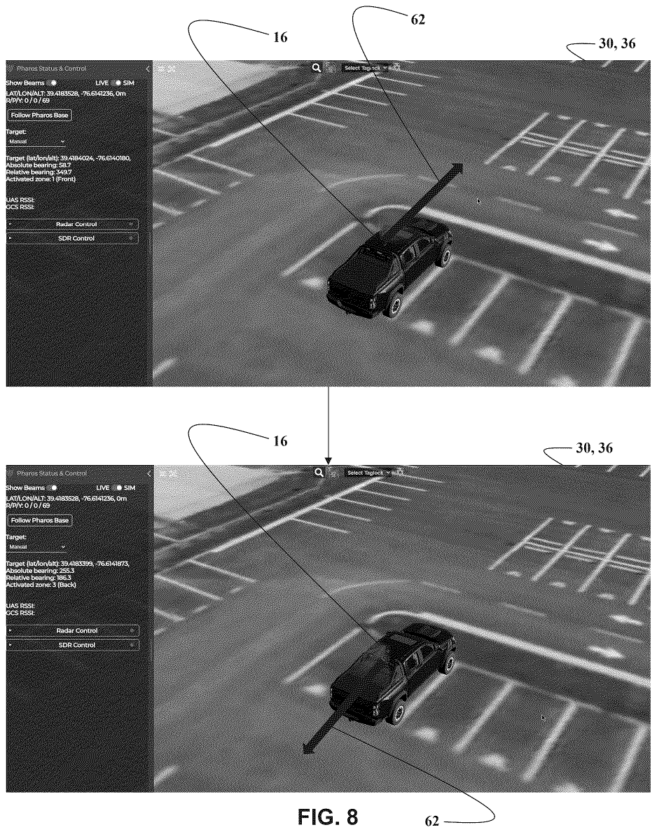

FIGS. 5-6 are flow charts of algorithms 200 and 300 performed by the one or more processors 56 of the control unit 42 to operate the antenna array 16. The algorithms include a plurality of steps. Each algorithm step may be performed independently of, or in combination with, other algorithm steps. Portions of the algorithms may be performed by any one of, or any combination of, the components of the autonomous interference-resistance geospatial antenna system 10. FIGS. 7-8 are exemplary screenshots of monitoring dashboards 36 that may be displayed on the GUI display screen 30 of the user computing devices 26 illustrating algorithms 200 and 300.

For example, in algorithm step 202, the one or more processors 56 receives a request including a geographic target location. For example, in some embodiments, the one or more processors 56 render the monitoring dashboard 36 on the GUI display screen 30 including a three-dimensional topographical map images displaying a geographic location of the antenna array 16, and the current geographic coordinates 58 of the antenna array 16. The monitoring dashboard 36 is configured to allow the user to select a geographic target location 60 via the monitoring dashboard 36 using a user input device such as, for example, a computer mouse, a touch pen, a touchscreen, and the like. The monitoring dashboard 36 also displays location data 62 associated with the selected geographic target location 60 including corresponding the geographic coordinates, absolute bearing, and relative bearing.

In algorithm step 204, upon receiving the selected geographic target location 60, the one or more processors 56 identifies the direction RF antennas 18 directed towards the selected geographic target location 60. For example, upon receiving the selected geographic target location 60, the one or more processors 56 may receive current geographic directional values of each directional RF antenna 18 from the attitude sensing device 38, and identify a group of directional RF antennas 18 orientated towards a direction of the geographic target location 60 based on the current geographic directional values of each directional RF antenna 18.

In algorithm step 206, the one or more processors 56 then receives current SNR values for each directional RF antenna 18 from the SDR device 40 to determine the directional RF antennas 18 having the highest SNR ratio. For example, the one or more processors 56 may operate the SDR device 40 to sequentially activate each directional RF antenna 18 to determine the SNR value for each directional RF antenna 18.

In algorithm step 208, the one or more processors 56 then selects a directional RF antenna 18 based on the current SNR values, the current geographic directional values of each directional RF antenna 18 received from the attitude sensing device 38, and the received geographic target location 60, and operates the RF switching device 20 to activate the selected directional RF antenna 18. For example, upon receiving the selected geographic target location 60 via the monitoring dashboard 36, the one or more processors 56 may operate the SDR device 40 to operate the RF switching device 20 to sequentially activate each directional RF antenna 18 to determine the SNR value for each directional RF antenna 18, receive the current geographic directional values of each directional RF antenna 18 from the attitude sensing device 38 and identify the group of directional RF antennas 18 orientated towards a direction of the selected geographic target location 60 based on the current geographic directional values of each directional RF antenna 18, select the directional RF antenna 18 from the identified group of directional RF antennas that has the highest current SNR value, and operate the RF switching device 20 to activate the selected directional RF antenna (shown in FIGS. 7-8 as arrow 62).

In some embodiments, upon receiving the selected geographic target location 60, the antenna control system 22 may execute algorithm 300 to sequentially scan each directional RF antenna 18 and compare the SNR values for each scan. The antenna control system 22 then select the directional RF antenna 18 having the highest SNR value and determines whether the selected directional RF antenna 18 is stable before operating the RF switching device 20 to activate the selected directional RF antenna. The antenna control system 22 then monitors the SNR values of each directional RF antenna 18 periodically to detect interferences.

In algorithm step 210, the one or more processors 56 then monitors the active directional RF antenna 18 to detect an interference signal affecting the active directional RF antenna 18. For example, the one or more processors 56 may periodically determine a corresponding SNR value associated with the active directional RF antenna 18 using the SDR device 40 and detect the interference associated with the activated directional RF antenna 18 upon determining the corresponding SNR value is below a predefined SNR threshold value.

In algorithm step 212, upon detecting an interference signal affecting the active directional RF antenna 18, the one or more processors 56 then sequentially determine SNR values for each SNR value for each directional RF antenna 18 and operate the RF switching device 20 to activate another directional RF antenna 18 having the highest SNR value. For example, the one or more processors 56 may detect an interference associated with the activated directional RF antenna 18 and select another directional RF antenna (shown in FIG. 8 as arrow 64) by operating the SDR device 40 to sequentially activate each directional RF antenna 18 to determine the SNR value for each directional RF antenna 18, identify the group of directional RF antennas 18 orientated towards a direction of the geographic target location 60 based on the current geographic directional values of each directional RF antenna 18, and activate the directional RF antenna 18 from the identified group of directional RF antennas having the highest current SNR value.

In some embodiments, the one or more processors 56 may select the directional RF antenna 18 orientated in away from or in an opposite direction to the directional RF antenna 18 affected by the interference signal.

The one or more processors 56 may also periodically scan each directional RF antenna 18 to determine current SNR values and activate a directional RF antenna having the highest current SNR value. For example, the one or more processors 56 may periodically scan each directional RF antenna 18 to determine current SNR values, detect an interference signal based on the current SNR values, determine a direction of the interference signal based on the current SNR values and current geographic directional values of each directional RF antenna 18, and activate a current directional RF antenna 18 orientated away from the direction of the interference signal.

In some embodiments, the antenna control system 22 may be programmed to execute a control algorithm including periodically scanning each antenna and selects the one with the best SNR, data logging to store historical SNR data for analysis and decision-making improvements. The antenna control system 22 may also generate data displayed in a user interface including the monitoring dashboard 36 to visualize real-time performance and system status, and use automation scripts that are configurable scripts to adjust scanning intervals and optimize operation based on environmental factors.

The antenna control system 22 may also operate through a sequential process of signal evaluation and antenna switching to maximize signal quality and integrity. Key functionalities include: 1) Periodic Antenna Scanning: i. Activates each antenna sequentially, ii. Measures and records SNR for analysis, and iii. Identifies patterns of interference; 2) Adaptive Antenna Selection: i. Compares SNR across all antennas, ii. Switches to the antenna with the strongest and cleanest signal, and iii. Ignores antennas with persistent interference; 3) Continuous Monitoring and Re-Evaluation: i. Performs periodic checks to adjust for changing interference conditions, ii. Dynamically adapts scanning frequency based on environmental factors, and iii. Maintains operational logs for performance review; and 4) User Notifications and Alerts: i. Provides alerts when interference exceeds predefined thresholds, and ii. Logs switch events for diagnostics and optimization.

In some embodiments, the autonomous interference-resistance geospatial antenna system 10 includes:
1) Dynamic Multi-Antenna Array with Directional Control: the system consists of a multi-antenna array, each antenna oriented in a geographic direction and connected to a central RF switch. The switch autonomously selects the appropriate antenna based on either a target geographic location or detected interference. This system introduces an intelligent algorithm that processes location commands to activate the antenna oriented toward the specified geographic coordinates. When interference is detected, the system overrides the location-based selection and instead activates the antenna least impacted by interference and closest to the desired geographic target location.
2) Real-Time Interference Detection with Software Defined Radio (SDR): A Software Defined Radio (SDR) component continuously scans the RF environment spatially, identifying and analyzing interference or jamming signals intensified in particular bearings. The SDR uses advanced signal analysis, detecting variations in the signal-to-noise ratio, frequency, and amplitude to characterize interference. When jamming or interference is detected, the system calculates the interference source's direction relative to the antenna's location, selecting an antenna facing away from it to enhance signal reception.
3) Autonomous Adaptive Response Mechanism: The system operates autonomously, switching antennas based on real-time interference and location data without manual intervention. When a latitude and longitude coordinate is sent, the system's control logic calculates the optimal antenna to activate. If interference appears, it pivots to an alternative antenna facing away from the interference source, thus maintaining uninterrupted connectivity. This novel adaptive response mechanism is distinct from prior solutions, offering interference resilience through automated antenna selection in diverse RF environments.
4) Precision Geospatial Awareness and Directional Control: An integrated GPS and IMU continuously determine the system's geographic position and orientation, enabling precise directional alignment for each antenna. Combined with SDR-based interference detection, the system ensures connectivity in complex RF environments by dynamically adjusting its directional response based on location or interference.

The autonomous interference-resistance geospatial antenna system 10 is particularly suited for applications in remote sensing, defense, and emergency communication, where maintaining reliable connectivity is essential despite potential RF interference. The system's autonomous response capability makes it ideal for high-interference scenarios such as conflict zones, high-density urban areas, and disaster relief zones where traditional directional antennas might struggle to maintain signal integrity.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to, only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The above description of illustrated examples of the present invention are not intended to be exhaustive or to be limited to the precise forms disclosed. While specific embodiments of, and examples for, the invention are described herein for illustrative purposes, various equivalent modifications are possible without departing from the broader spirit and scope of the present invention.

What is claimed is:

1. An autonomous interference-resistance geospatial antenna system, comprising:
an antenna array including a plurality of directional Radio Frequency (RF) antennas, each directional RF antenna orientated in a different geographic direction;
an RF switching device coupled to the antenna array and configured to selectively operate each directional RF antenna; and
an antenna control system operatively coupled to the RF switching device and antenna array, the antenna control system including:
an attitude sensing device configured to determine geographic directional values of each directional RF antenna including a corresponding geographic location and orientation;
a software defined radio (SDR) device configured to determine a signal to noise ratio (SNR) value for each directional RF antenna; and
a control unit including one or more processors programed to execute an algorithm to operate the antenna array including the steps of:
receiving a request including a geographic target location;
receiving current geographic directional values of each directional RF antenna from the attitude sensing device;
receiving current SNR values for each directional RF antenna from the SDR device;
selecting a directional RF antenna based on the current SNR values, the current geographic directional values, and the received geographic target location; and
operating the RF switching device to activate the selected directional RF antenna.

2. The system of claim 1, wherein the one or more processors is programmed to execute the algorithm including the steps of:
operating the SDR device to sequentially activate each directional RF antenna to determine the SNR value for each directional RF antenna.

3. The system of claim 2, wherein the one or more processors is programmed to execute the algorithm including the steps of:
identifying a group of directional RF antennas orientated towards a direction of the geographic target location based on the current geographic directional values of each directional RF antenna; and
selecting the directional RF antenna from the identified group of directional RF antennas having the highest current SNR value.

4. The system of claim 1, wherein the one or more processors is programmed to execute the algorithm including the steps of:
detecting an interference associated with the activated directional RF antenna; and
selecting another directional RF antenna by:
operating the SDR device to sequentially activate each directional RF antenna to determine the SNR value for each directional RF antenna;
identifying a group of directional RF antennas orientated towards a direction of the geographic target location based on the current geographic directional values of each directional RF antenna; and
activating the directional RF antenna from the identified group of directional RF antennas having the highest current SNR value.

5. The system of claim 4, wherein the one or more processors is programmed to execute the algorithm including the steps of:
periodically determining a corresponding SNR value associated with the active directional RF antenna; and
detecting the interference associated with the activated directional RF antenna upon determining the corresponding SNR value is below a predefined SNR threshold value.

6. The system of claim 1, wherein the one or more processors is programmed to execute the algorithm including the steps of:
periodically scanning each directional RF antenna to determine current SNR values; and
activating a directional RF antenna having the highest current SNR value.

7. The system of claim 1, wherein the one or more processors is programmed to execute the algorithm including the steps of:
periodically scanning each directional RF antenna to determine current SNR values;
detecting an interference signal based on the current SNR values;
determining a direction of the interference signal based on the current SNR values and current geographic directional values of each directional RF antenna; and
activating a current directional RF antenna orientated away from the direction of the interference signal.

8. The system of claim 1, wherein the antenna array includes four directional RF antennas with 90° beamwidth covering full azimuthal space.

9. A method of operating an autonomous interference-resistance geospatial antenna system including an antenna array including a plurality of directional Radio Frequency (RF) antennas, each directional RF antenna orientated in a different geographic direction, an RF switching device coupled to the antenna array and configured to selectively operate each directional RF antenna, and an antenna control system including an attitude sensing device configured to determine geographic directional values of each directional RF antenna including a corresponding geographic location and orientation, a software defined radio (SDR) device configured to determine a signal to noise ratio (SNR) value for each directional RF antenna, and a control unit including one or more processors, the method including the one or more processors performing an algorithm to operate the antenna array including the steps of:
receiving a request including a geographic target location;
receiving current geographic directional values of each directional RF antenna from the attitude sensing device;
receiving current SNR values for each directional RF antenna from the SDR device;
selecting a directional RF antenna based on the current SNR values, the current geographic directional values, and the received geographic target location; and
operating the RF switching device to activate the selected directional RF antenna.

10. The method of claim 9, including the one or more processors performing the algorithm including the steps of:
operating the SDR device to sequentially activate each directional RF antenna to determine the SNR value for each directional RF antenna.

11. The method of claim 10, including the one or more processors performing the algorithm including the steps of:
identifying a group of directional RF antennas orientated towards a direction of the geographic target location based on the current geographic directional values of each directional RF antenna; and
selecting the directional RF antenna from the identified group of directional RF antennas having the highest current SNR value.

12. The method of claim 9, including the one or more processors performing the algorithm including the steps of:
detecting an interference associated with the activated directional RF antenna; and
selecting another directional RF antenna by:
operating the SDR device to sequentially activate each directional RF antenna to determine the SNR value for each directional RF antenna;
identifying a group of directional RF antennas orientated towards a direction of the geographic target location based on the current geographic directional values of each directional RF antenna; and
activating the directional RF antenna from the identified group of directional RF antennas having the highest current SNR value.

13. The method of claim 12, including the one or more processors performing the algorithm including the steps of:
periodically determining a corresponding SNR value associated with the active directional RF antenna; and
detecting the interference associated with the activated directional RF antenna upon determining the corresponding SNR value is below a predefined SNR threshold value.

14. The method of claim 9, including the one or more processors performing the algorithm including the steps of:
periodically scanning each directional RF antenna to determine current SNR values; and
activating a directional RF antenna having the highest current SNR value.

15. The method of claim 9, including the one or more processors performing the algorithm including the steps of:
periodically scanning each directional RF antenna to determine current SNR values;
detecting an interference signal based on the current SNR values;
determining a direction of the interference signal based on the current SNR values and current geographic directional values of each directional RF antenna; and
activating a current directional RF antenna orientated away from the direction of the interference signal.

16. The method of claim 9, wherein the antenna array includes four directional RF antennas with 90° beamwidth covering full azimuthal space.

17. A non-transitory computer-readable storage media having computer-executable instructions embodied thereon to operate an autonomous interference-resistance geospatial antenna system including an antenna array including a plurality of directional Radio Frequency (RF) antennas, each directional RF antenna orientated in a different geographic direction, an RF switching device coupled to the antenna array and configured to selectively operate each directional RF antenna, and an antenna control system including an attitude sensing device configured to determine geographic directional values of each directional RF antenna including a corresponding geographic location and orientation, a software defined radio (SDR) device configured to determine a signal to noise ratio (SNR) value for each directional RF antenna, and a control unit including one or more processors, when executed by the one or more processors the computer-executable instructions cause the one or more processors to perform an algorithm including the steps of:
receiving a request including a geographic target location;
receiving current geographic directional values of each directional RF antenna from the attitude sensing device;
receiving current SNR values for each directional RF antenna from the SDR device;
selecting a directional RF antenna based on the current SNR values, the current geographic directional values, and the received geographic target location; and
operating the RF switching device to activate the selected directional RF antenna.

18. The non-transitory computer-readable storage media of claim 17, wherein the computer-executable instructions cause the one or more processors to perform the algorithm including the steps of:
operating the SDR device to sequentially activate each directional RF antenna to determine the SNR value for each directional RF antenna.

19. The non-transitory computer-readable storage media of claim 18, wherein the computer-executable instructions cause the one or more processors to perform the algorithm including the steps of:
identifying a group of directional RF antennas orientated towards a direction of the geographic target location based on the current geographic directional values of each directional RF antenna; and
selecting the directional RF antenna from the identified group of directional RF antennas having the highest current SNR value.

20. The non-transitory computer-readable storage media of claim 17, wherein the computer-executable instructions cause the one or more processors to perform the algorithm including the steps of:
detecting an interference associated with the activated directional RF antenna; and
selecting another directional RF antenna by:
operating the SDR device to sequentially activate each directional RF antenna to determine the SNR value for each directional RF antenna;
identifying a group of directional RF antennas orientated towards a direction of the geographic target location based on the current geographic directional values of each directional RF antenna; and
activating the directional RF antenna from the identified group of directional RF antennas having the highest current SNR value.
